(19) United States
(12) Patent Application Publication
(10) Pub. No.: US 2015/0300727 A1
(43) Pub. Date: Oct. 22, 2015

(54) PORTABLE COOLER WITH INTEGRATED SOUND SYSTEM

(71) Applicant: David Abbate, Tampa, FL (US)

(72) Inventor: David Abbate, Tampa, FL (US)

(21) Appl. No.: 14/254,789

(22) Filed: Apr. 16, 2014

(51) Int. Cl. F25D 23/12; H04B 1/08

(52) U.S. Cl. CPC F25D 23/12; H04B 1/086; F25D 2331/804

(57) ABSTRACT

An insulated portable cooler with an integrated sound system is disclosed having a polymeric outer housing, a concave inner compartment, a bass speaker, a plurality of smaller speakers, and an amplifier affixed to an outer surface of the cooler. Various embodiments of the present invention include a lid comprising a speaker and/or an internal battery for powering the speakers, amplifiers and electromechanical components of the disclosed cooler and sound system.

### BACKGROUND OF THE INVENTION

1. Field of the Invention

This invention relates to portable coolers and sound systems, and more particularly relates to a portable cooler having an integrated sound system.

2. Description of the Related Art

Portable coolers are well-known in the art and used in a multitude of recreational activities for keeping perishable foods and beverages cool away from refrigerators and power supplies, often on boats, campers, at concerts, or during outdoor activities. Recorded music, video and other media are often brought on these recreational trips for entertainment and use with audio systems integrated into vehicles, such as boats, trucks, campers, and the like.

When vehicles having integrated audio systems are unavailable, individuals commonly carry portable battery-powered audio sound systems along with them, such as boom-boxes and iPod® speaker attachment. Often, individuals and groups of individuals find it difficult and cumbersome to transport both a portable cooler and portable audio system to a remote location, despite greatly desiring to transport both.

Though portable audio systems and portable coolers are functionally unrelated, both are related to outdoor entertainment generally. There exist no devices in the art which have optimally combined a portable cooler and a performance portable audio system for use of use and transport. It is therefore desirable that an efficient compact, portable cooler with an integrated performance audio system be provided which meets or exceeds the performance expectations of music enthusiasts while also keeping perishables cool during recreational activities.

### SUMMARY OF THE INVENTION

From the foregoing discussion, it should be apparent that a need exists for a portable cooler with an integrated sound/multimedia system. Beneficially, such an apparatus would overcome many of the difficulties with prior art by providing a device with integrated performance components that functions well.

The present invention has been developed in response to the present state of the art, and in particular, in response to the problems and needs in the art that have not yet been fully solved by currently available methods and apparatii. Accordingly, the present invention has been developed to provide a portable cooler and sound system comprising: an outer polymeric housing, the outer housing defining a larger aperture for receiving a bass speaker, the outer housing defining a plurality of smaller apertures for receiving smaller speakers; wherein the outer polymeric housing has a forward surface, a rearward surface, two lateral surfaces, a bottom surface, and a top opening for accessing an inner compartment; wherein the outer polymeric housing defines two or more apertures for interconnecting audio cables from outside the portable cooler to the inner compartment; a concave inner compartment affixed within the outer housing, the outer housing and inner compartment defining a hollow recess between them, the hollow recess filled with an insulating material; a bass speaker affixed within the larger aperture; a plurality of speakers, each speaker affixed within a smaller aperture; an amplifier affixed to the rearward surface of the outer housing such that the amplifier does not heat the inner compartment and such that the amplifier is not exposed to moisture in the inner compartment.

In some embodiments, the portable cooler and sound system further comprise a mounting bracket for detachably mounting a portable media player to the portable cooler.

In other embodiments, the portable cooler and sound system further comprise one of a car battery and one or more lithium ion batteries within the inner compartment for powering the amplifier, bass speaker, and smaller speakers.

In still further embodiments, the portable cooler and sound system comprise a polymeric sheet overlaying the one or more batteries.

The portable cooler and sound system may further comprise an insulated lid hingedly connected to the portable cooler such that the lid closes over the top opening. IN some embodiments, the portable cooler and sound system also comprise one or more speakers affixed to the lid.

The portable cooler may also comprise a plurality of wheels for rolling the portable cooler across a ground surface. In still further embodiments, the portable cooler and sound system comprise a microphone. The portable cooler and sound system may comprise an aperture for improving the resonance of a subwoofer.

The portable cooler and sound system may further comprising a bottle opener affixed to the outer polymeric housing. In still further embodiments, the portable cooler and sound system comprise a detachable light-emitting assembly affixable to the cooler for special visual effects. The portable cooler and sound system may also comprise one or more photovoltaic cells affixed to a lid of the cooler for charging an internal battery.

The portable cooler and sound system may further comprise a 12 volt cigarette lighter socket. The portable cooler and sound system may also further comprise a power inverter in electrical connection with an internal battery. The portable cooler and sound system may comprise a male USB connector for charging data processing devices.

The portable cooler and sound system may further comprise a plurality of light emitting diodes affixed to the outer polymeric housing.

A second portable cooler and sound system produced by a process of manipulating a portable cooler is disclosed, the product by process comprising: cutting a larger aperture for receiving a bass speaker into a lid of a cooler; cutting one or more smaller apertures for receiving smaller speakers into a body of a cooler, wherein the body of the cooler has a forward surface, a rearward surface, two lateral surfaces, a bottom surface, and a top opening for accessing an inner compartment; drilling two or more apertures through the body of the cooler for facilitating the audio cable connectivity from outside the portable cooler into the inner compartment; affixing a bass speaker within the larger aperture; affixing a smaller speaker within each of the smaller aperture(s); and affixing an amplifier to the rearward surface of the outer housing such that the amplifier does not heat the inner compartment and such that the amplifier is not exposed to moisture in the inner compartment.

The portable cooler and sound system may further be formed by affixing a mounting bracket for detachably mounting a portable media player to the cooler. The portable cooler and sound system may further be formed by affixing a car battery within the cooler for powering the amplifier, bass speaker, and smaller speakers.

The portable cooler and sound system may also be formed by affixing one or more speakers to a lid of the cooler.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a rear elevational perspective view of a portable cooler and sound system in accordance with the present invention;

FIG. 2 is a forward elevational perspective view of a portable cooler and sound system in accordance with the present invention;

FIG. 3 is a side elevational perspective view of a portable cooler and sound system in accordance with the present invention;

FIG. 4 is a side elevational perspective view of a portable cooler and sound system in accordance with the present invention;

FIG. 5A is a side elevational perspective view of a portable cooler with an integrated sound system in accordance with the present invention;

FIG. 5B is a lower elevational perspective view of a portable strobe light assembly in accordance with the present invention;

FIG. 5C is a side elevational perspective view of a power inverter in accordance with the present invention;

FIG. 6 is a side elevational perspective view of a portable cooler with an integrated sound system in accordance with the present invention; and

FIG. 7 is a sectioned elevational perspective view of a portable cooler with integrated batteries in accordance with the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

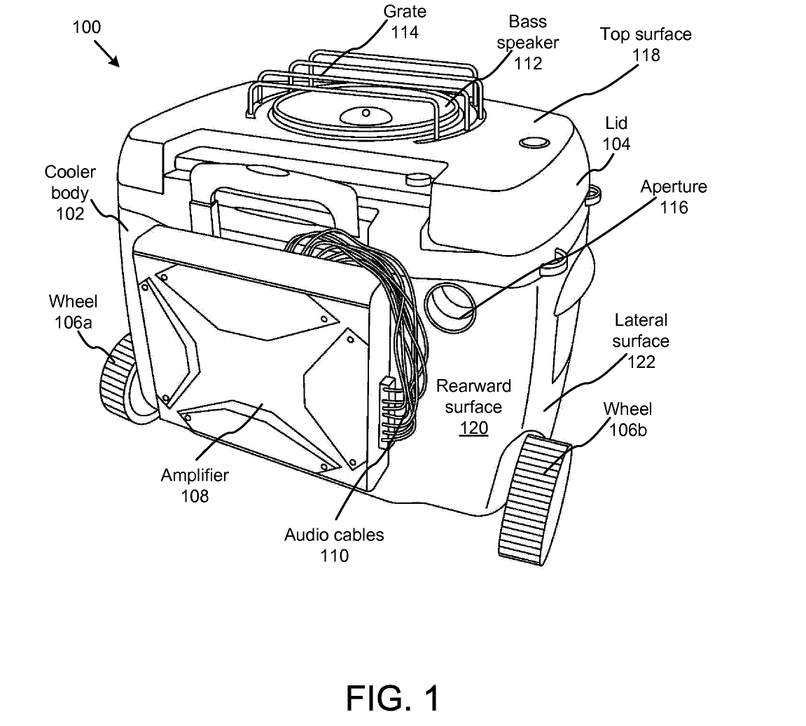

FIG. 1 is a rear elevational perspective view of a portable cooler and sound system 100 in accordance with the present invention. The portable cooler and sound system 100 comprises a cooler body 102, a lid 104, a wheel 106a, a wheel 106b, an amplifier 108, audio cables 110, a bass speaker 112, and a grate 114, an aperture 116, a top surface 118, a rearward surface 120, and a lateral surface 122.

The cooler body 102 is well-known to those of skill in the art. The cooler 102 comprises an outer housing having a forward surface, a top surface 118, a rearward surface 120, a bottom surface, and two lateral surfaces 122.

The cooler 100 comprises a lid 104 which is hingedly affixed to the cooler 102. The cooler 102 has been modified to comprise an integrated sound system. The cooler 102 has had a recess or aperture drilled or cut into the top surface of the lid 104 for receiving a bass speaker 112.

The bass speaker 112 traverses the entire lid 104 longitudinally and juts into the interior of the cooler 102 where it is interconnected electrically with one or more other electrical or electromechanical components of the cooler 100.

The lid 104 and/or the cooler body 102 may also be drilled or cut to define an aperture 116, bore hole, or recess for interconnecting audio cables 110 between the amplifier 108 and internal components such as a batter, speakers, receiver, and the like.

The amplifier 108 is well-known to those of skill in the art. The amplifier 108 may comprise a more durable amplifier which is water resistant, such as a marine amplifier. The amplifier is affixed exteriorly to the cooler 100 rather interiorly to avoid heating the inside of the interior of cooler 100 during operation and to save space within the cooler 100.

In other embodiments of the present invention one or more amplifiers 108 may additionally or alternatively be affixed to the lateral surfaces and/or forward surface of the cooler body 102.

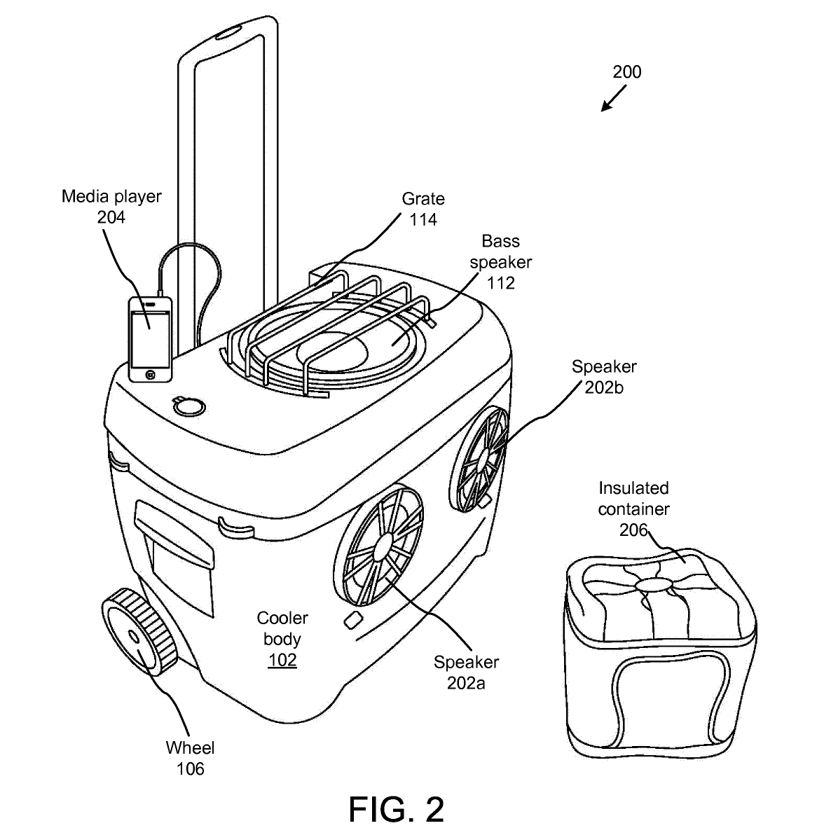

FIG. 2 is a forward elevational perspective view of a portable cooler and sound system 200 in accordance with the present invention. The portable cooler and sound system 200 comprises a cooler body 102, a wheel 106, a bass speaker 112, a grate 114, a speaker 202a, a speaker 202b, a digital media player 204, and an insulated container 206.

The cooler 102 is substantially described above in relation to FIG. 1.

Like the speakers 202a-b, the bass speaker 112 comprises an electroacoustic transducer that produces sound in response to an electrical audio signal input, however the bass speaker 112 is designed and configured to optimally produce sound of a lower frequency than the speakers 202a-b. For this reason, the bass speaker 112 is usually wider, in most embodiments, than the speakers 202a-b.

In various embodiments, the lid 104 or outer housing comprises a mounting bracket or docking station for detachably affixing a portable digital media player 204 to the device 300, such as an iPod® or the like.

The grate 114 comprises an alloy, metal, wood, or polymeric protective frame affixed to the cooler body 102 or the lid 104 to protect the bass speaker 112 or one of the speakers 202a-b from impact damage from blunt objects.

An insulated waterproof container 206 is also disclosed comprising a flexible polymeric outer bladder. In some embodiments, the container 206 also comprises a waterproof inner lining A layer of insulation between the outer bladder and inner lining.

The container 206 is insertable into the cooler 200 and meant to protect one variety of perishables from moisture or other contaminants in the cooler 200, such as the battery, spoiled fish, and the like. The container 206 may be fabricated from flexible or rigid elastomeric materials.

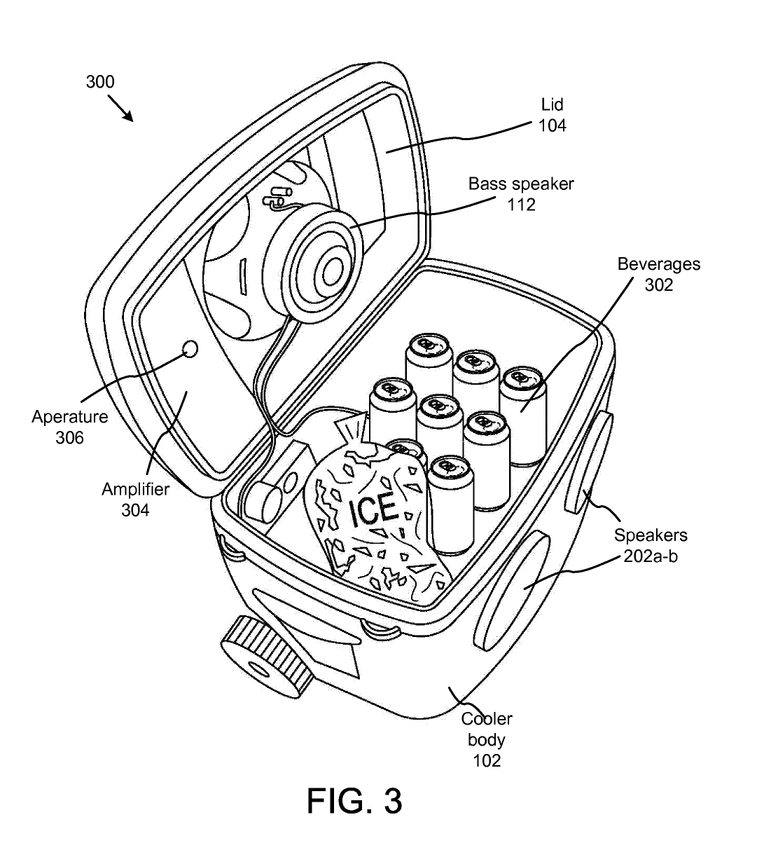

FIG. 3 is a side elevational perspective view of a portable cooler and sound system 300 in accordance with the present invention. The portable cooler and sound system 300 comprises a cooler body 102, a lid 104, a base speaker 112, a speaker 202a, a speaker 202b, beverages 302 and an amplifier 304.

The cooler 300 is power by an external power supply (not shown). In various embodiments, the cooler 400 is powered by 120 volt A/C power, 220 volt A/C power, 12 volt D/C power, and the like. The cooler 400 may comprise plugs designed to interconnect with a cigarette-lighter socket of a vehicle or a standard electrical wall socket in a building or on a generator.

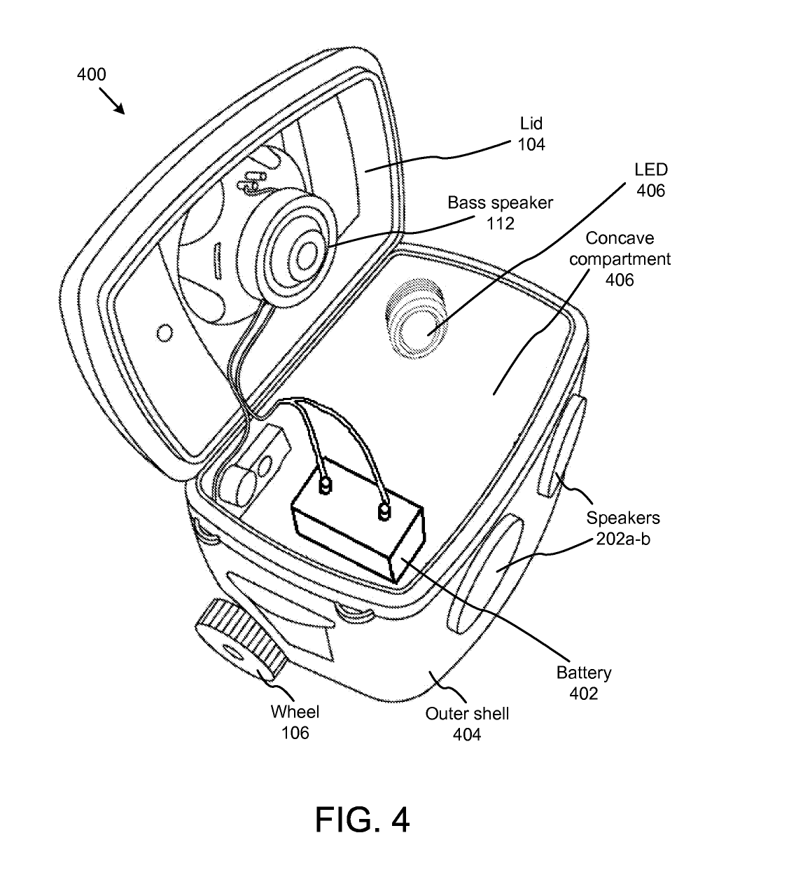

FIG. 4 is a side elevational perspective view of a portable cooler and sound system 400 in accordance with the present invention. The portable cooler and sound system 400 comprises a lid 104, a wheel 106, a base speaker 112, a battery 402, outer shell 404, and a concave compartment 406.

The cooler 102, wheel 106, base speaker 112 are all substantially described above in relation to FIGS. 1-3.

The cooler 400 comprises a battery 402. In the shown embodiment, the battery 402 is a car battery housed interiorly within the cooler 400 for powering the amplifier 108, speakers 112, 202a-b, and other components of the cooler 400. In various other embodiments of the present invention, the battery 402 comprises a plurality of batteries of standardized sizes and outputs connected in series or in parallel within a polymeric housing, the polymeric housing affixed interiorly or exteriorly to the cooler body 102.

The battery 402 may comprise either a lead-acid battery, a lithium ion battery, and/or a lithium phosphate battery, and/or any other battery known to those of skill in the art. In various embodiments, a plurality of planar lithium ion batteries 402 are disposed in planar fashion across the bottom surface of the inner compartment to maximize usable volume above the batteries 402 within the inner compartment. In these embodiments, a false bottom, or polymeric plate, may be disposed above the batteries 402, separating them from the contents of the inner compartment.

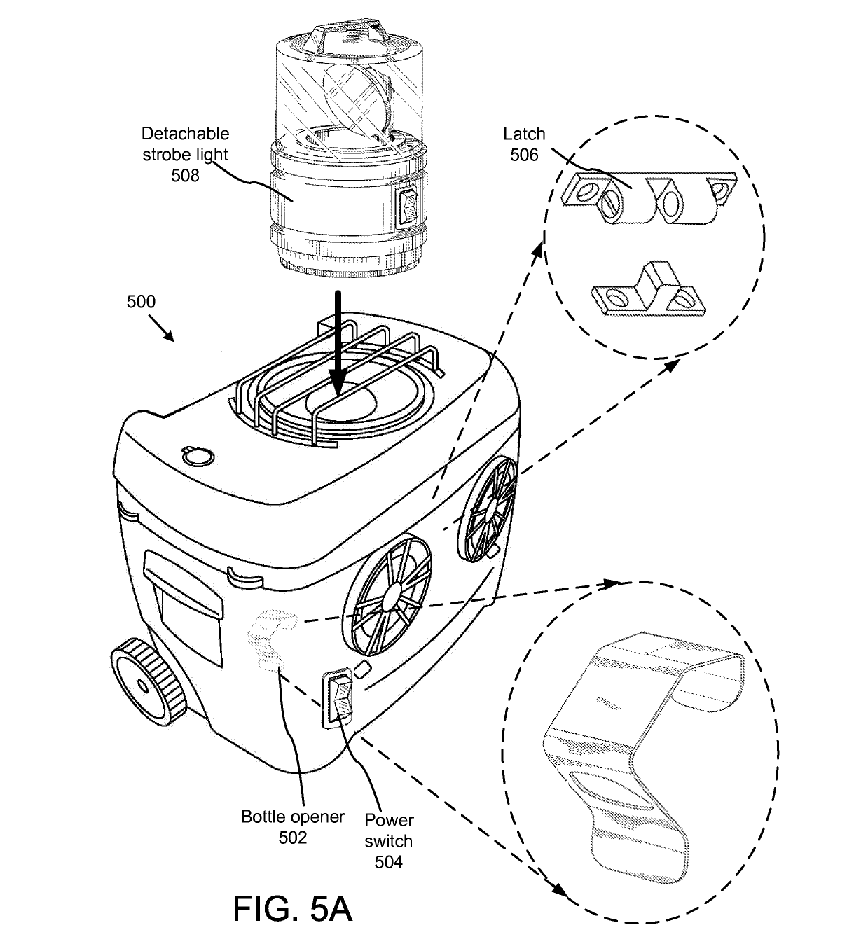

FIG. 5A is a side elevational perspective view of a portable cooler with an integrated sound system 500 in accordance with the present invention. The cooler 500 comprises a bottle opener 502, a power switch 504, a latch 506, and a detachable strobe light assembly 508.

The bottle opener 502 is known to those of skill in the art, and is affixed to the exterior of the cooler body 102. In the shown embodiment, the bottle opener 502 comprises a sold metallic implement defining an aperture for receiving the caped end of a bottle. In other embodiments, the bottle opener 502 consists of, comprises or defines an opening, hole, or aperture in the cooler body 102 for receiving the capped end of a bottle.

The power switch 504 is well-known to those of skill in the art, and is used to power on the speakers 202, amplifier 108, and other components of the cooler 500 from either an internal or external power supply.

The latch 506 is well-known to those of skill in the art. In the shown embodiment, the latch 506 comprises two interlocking components, each of which is affixed either to the lid 104 or the cooler body 102. The latch 506 may be locked in a closed position such that it cannot be opened with a key or combination, or may define or comprise a channel through which a padlock may used to lock the latch 506 and secure the inner components of the cooler 500 from theft.

In various embodiments, the cooler 500 is detachably affixable to a strobe light assembly 508. The lid 104 may comprise a concave depression, aperture, rack, mount or the like for engaging and affixing the detachably strobe light assembly 508 to the lid 104. In these embodiments, the strobe light assembly 508 is connected to the power supply of the cooler 500 and operable with its own power switch.

The detachable strobe light assembly 508 may be replaced with a flashing, oscillating or moving laser light assembly, reflective ball, or other similar apparatus for provided special light effects to dancers and party-goers.

FIG. 5B is a lower elevational perspective view of a portable strobe light assembly 520 in accordance with the present invention. The strobe light assembly 520 may be detachably affixed to the top surface 118 of the cooler 500. Alternatively, the strobe light assembly 520 may stand alone on a ground surface in close proximity to the cooler 500, affixed to the cooler 500 with cables and powered by the power source powering the cooler 500.

FIG. 5C is a side elevational perspective view of a power inverter 540 in accordance with the present invention. The power inverter 540 is known to those of skill in the art. In accordance with the present invention, the power inverter 540 may be affixed to the cooler 100 in place of the amplifier 108, on top of the amplifier 108, or inside or outside the cooler 100 such that the power inverter 540 is accessible by a user of the cooler 100.

The power inverter 540 is affixed to the battery 402 and converters D/C power from the battery 504 into A/C power needed by many household appliances and devices.

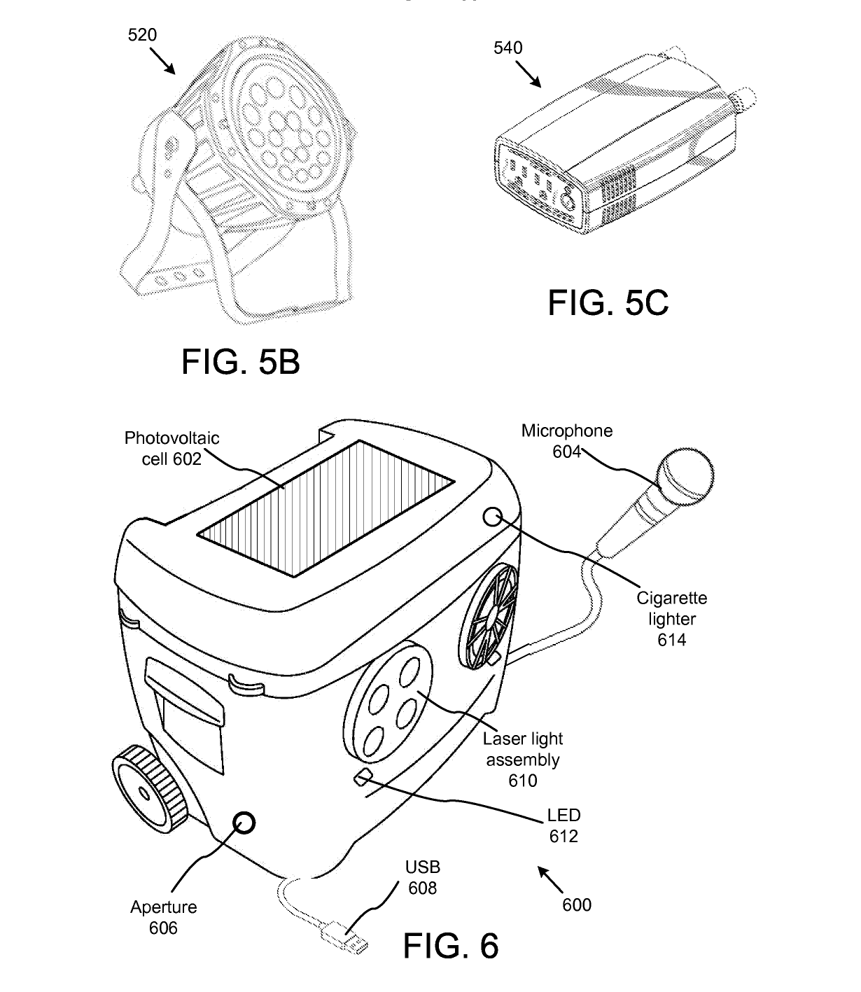

FIG. 6 is a side elevational perspective view of a portable cooler with an integrated sound system 600 in accordance with the present invention. The cooler 600 comprises a photovoltaic cell 602, a microphone 604, an aperture 606, a USB cable 608, and a laser light assembly 610.

The photovoltaic cell 602 may comprise a single photovoltaic cell or an interconnected assembly of photovoltaic cells. The photovoltaic cell 602 may comprise multiple cells combined into a photovoltaic array or solar energy panel.

The photovoltaic cell 602 is configured, in the shown embodiment, to direct electrical current to charge to a converters, power inverter 540, battery 402, or other batteries 402 of various kinds, including wet-cell lead acid batteries, absorbed glass mat (AGM) batteries, nickel-cadmium, and lithium-ion.

The photovoltaic cell 602 may be rigid or flexible, and may comprise flexible thin solar modules, or nano thin solar panels formed by depositing a photoactive layer over a flexible substrate, such as solar-absorbing “nano-ink,” or inorganic nano-crystals. In short, the photovoltaic cell 602 may be used to charge the battery 402 and subsequently power the cooler 600.

The photovoltaic cell 602 may cover all or a portion of the top surface 118.

The cooler 600 comprises one or more apertures 606 which traverse the cooler body 102. When the speakers 112, 202 in use they flex creating variances in air pressure within the cooler 600 affecting the performance of the speakers 112, 202. The present invention solves this performance degradation with apertures 606 that maintain the air pressure within the cooler 600 in equilibrium with the ambient air pressure surrounding the cooler 600. The aperture 606 may comprise a non-annular ported vent.

In some embodiments, the aperture 606 emits fog or smoke from an internal fog or smoke machine housed within the cooler 600. The fog may be emitted from a plurality of apertures 606 surrounding the cooler body 102.

The microphone 604 is well-known to those of skill in the art. In various embodiments, the microphone 604 is used by users for karaoke. Sound gathered at the microphone 604 is amplified by the amplifier 108 and recast by the speakers 112, 202 in real time, magnifying the voice a user singing into the microphone 604 over music being played by the speakers 112, 202.

The USB cable 608 is well-known to those of skill in the art and used to power a variety of data processing devices, including cellular phones, tablet computers, MP3 players, and the like. The cooler 600 includes a USB cable 608 for charging these data processing devices commonly ported by users as well as for, in some embodiments, interfacing with the data processing device and downloading media from it for playing on the speakers 112, 202 and the like.

The USB cable 608 may be affixed to the lid 104, the cooler body 102, the top surface 118, or to any other component of the cooler 600.

The laser light assembly 610, in the shown embodiment, is affixed within the concave depression or aperture reserved in other embodiments for a speaker 202. The laser light assembly replaces a speaker 202 and emits lasers for special effects commonly employed for dancing and parties. In other embodiments, the laser light assembly 610 emits strobe lights. In still further embodiments, the laser light assembly comprises, or is replaced with, a video projector or LEDs.

The exterior cooler body 102 may comprise a plurality of multicolored light emitting diodes 612. These LEDs 612 may be controlled by a data processing device to flash or activate in accordance with wave patterns in music played on the speakers 112, 202.

The cooler 600 may also comprise a 12 volt cigarette lighter 114 or socket for interconnecting with typical electrical devices intended for use with automobiles, such as cellular phone chargers. The cooler 600 may comprise one or more converters, for converting 12 volt power into 5 volt power for interconnectivity with Bluetooth devices and the like.

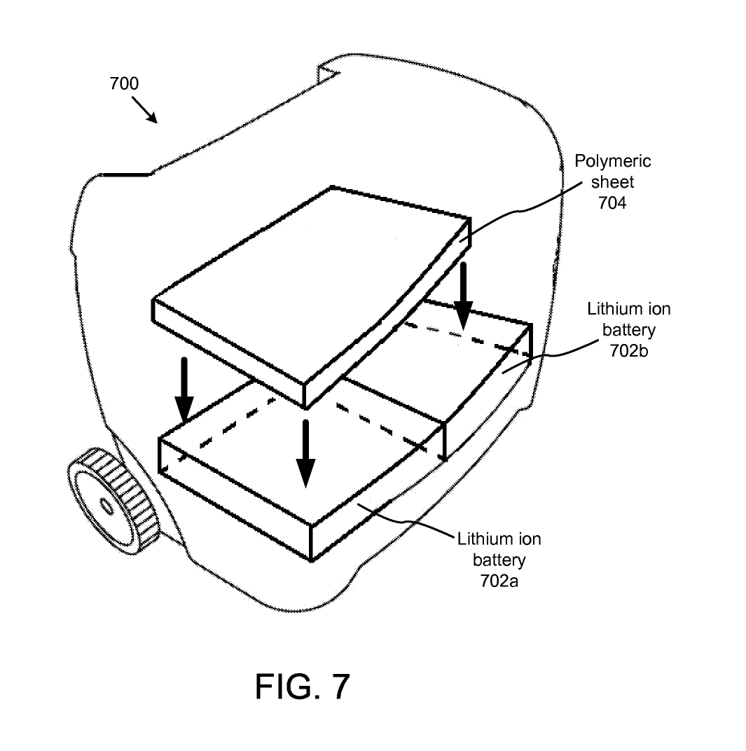

FIG. 7 is a sectioned elevational perspective view of a portable cooler 700 with integrated batteries in accordance with the present invention. The cooler 700 comprises a lithium ion battery 702a, a lithium ion battery 702b, and a polymeric sheet 704.

The lithium ion batteries 702a-b are well-known to those of skill in the art. These batteries 702a-b tend to be shaped in a flatter, more planar design than lead-acid car batteries 402, and are often used in complex electrical data processing devices, such as cellular phone, laptop computers, and MP3 players.

The shown embodiment 700 includes a plurality of batteries 702a-b disposed across the bottom inner surface of the inner compartment defined by the cooler 700. These batteries 702a-b are covered interiorly a polymeric sheet 704, which buffers and insulates the batteries 702a-b from perishable items placed within the cooler 700. In some embodiments, the polymeric sheet 704 is detachable, in other embodiments the polymeric sheet 702 is affixed permanently within the cooler 700; while is still further embodiments the polymeric sheet 704 is formed with the cooler 700 as one integrated piece.

In various embodiments, the batteries 702a-b may be affixed exteriorly to the cooler 700, including within recesses on the bottom surface of the cooler 700.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A portable cooler and sound system comprising:
an outer polymeric housing, the outer housing defining a larger aperture for receiving a bass speaker, the outer housing defining a plurality of smaller apertures for receiving smaller speakers;
wherein the outer polymeric housing has a forward surface, a rearward surface, two lateral surfaces, a bottom surface, and a top opening for accessing an inner compartment;
wherein the outer polymeric housing defines two or more apertures for interconnecting audio cables from outside the portable cooler to the inner compartment;
a concave inner compartment affixed within the outer housing, the outer housing and inner compartment defining a hollow recess between them, the hollow recess filled with an insulating material;
a bass speaker affixed within the larger aperture;
a plurality of speakers, each speaker affixed within a smaller aperture;
an amplifier affixed to the rearward surface of the outer housing such that the amplifier does not heat the inner compartment and such that the amplifier is not exposed to moisture in the inner compartment.

2. The portable cooler and sound system of claim 1, further comprising a mounting bracket for detachably mounting a portable media player to the portable cooler.

3. The portable cooler and sound system of claim 1, further comprising one of a car battery and one or more lithium ion batteries within the inner compartment for powering the amplifier, bass speaker, and smaller speakers.

4. The portable cooler and sound system of claim 3, further comprising a polymeric sheet overlaying the one or more batteries.

5. The portable cooler and sound system of claim 1, further comprising an insulated lid hingedly connected to the portable cooler such that the lid closes over the top opening.

6. The portable cooler and sound system of claim 4, further comprising one or more speakers affixed to the lid.

7. The portable cooler and sound system of claim 1, wherein the portable cooler further comprising a plurality of wheels for rolling the portable cooler across a ground surface.

8. The portable cooler and sound system of claim 1, further comprising a microphone.

9. The portable cooler and sound system of claim 1, further comprising an open aperture for improving the resonance of a subwoofer.

10. The portable cooler and sound system of claim 1, further comprising a bottle opener affixed to the outer polymeric housing.

11. The portable cooler and sound system of claim 1, further comprising a detachable light-emitting assembly affixable to the cooler for special visual effects.

12. The portable cooler and sound system of claim 1, further comprising one or more photovoltaic cells affixed to a lid of the cooler for charging an internal battery.

13. The portable cooler and sound system of claim 1, further comprising a 12 volt cigarette lighter socket.

14. The portable cooler and sound system of claim 1, further comprising a power inverter in electrical connection with an internal battery.

15. The portable cooler and sound system of claim 1, further comprising a male USB connector for charging data processing devices.

16. The portable cooler and sound system of claim 1, further comprising a plurality of light emitting diodes affixed to the outer polymeric housing.

17. A portable cooler and sound system produced by a process of manipulating a portable cooler, the product by process comprising:
cutting a larger aperture for receiving a bass speaker into a lid of a cooler;
cutting one or more smaller apertures for receiving smaller speakers into a body of a cooler, wherein the body of the cooler has a forward surface, a rearward surface, two lateral surfaces, a bottom surface, and a top opening for accessing an inner compartment;
drilling two or more apertures through the body of the cooler for facilitating the audio cable connectivity from outside the portable cooler into the inner compartment;
affixing a bass speaker within the larger aperture;
affixing a smaller speaker within each of the smaller aperture(s); and
affixing an amplifier to the rearward surface of the outer housing such that the amplifier does not heat the inner compartment and such that the amplifier is not exposed to moisture in the inner compartment.

18. The portable cooler and sound system of claim 8, further comprising affixing a mounting bracket for detachably mounting a portable media player to the cooler.

19. The portable cooler and sound system of claim 8, further comprising affixing a car battery within the cooler for powering the amplifier, bass speaker, and smaller speakers.

20. The portable cooler and sound system of claim 10, further comprising affixing one or more speakers to a lid of the cooler.
